(19) United States
(12) Patent Application Publication
(10) Pub. No.: US 2008/0156160 A1
(43) Pub. Date: Jul. 3, 2008

(54) Punch assisting apparatus

(75) Inventors: Ayano Yamashita, Tokyo (JP); Naoki Ozawa, Tokyo (JP); Hiroyuki Urabe, Kawasaki-shi (JP); Emiko Nakasato, Kawasaki-shi (JP)

Correspondence Address: OLIFF & BERRIDGE, PLC, P.O. BOX 320850, ALEXANDRIA, VA, 22320-4850, US

(73) Assignee: CARL MANUFACTURING CO., LTD., Tokyo (JP)

(21) Appl. No.: 11/987,787

(22) Filed: Dec. 4, 2007

(30) Foreign Application Priority Data
Dec. 5, 2006 (JP) 2006-328073

(51) Int. Cl. B26F 1/02; B26D 7/02; B26D 7/26; B26F 1/32

(52) U.S. Cl. 83/459; 83/613

(57) ABSTRACT

A punch assisting apparatus usable in combination with one of a plurality of punches includes an apparatus base and a handle pivotably attached to the apparatus base, the apparatus base being provided with a punch holder integrated therein which allows the plurality of punches having different sizes to be independently positioned and fixed in accordance with their respective sizes. The punch holder is configured so as to provide both a use position and a nonuse position by changing its posture; whereby, when a punch is mounted to the punch assisting apparatus to replace the one previously mounted, the punch can always be positioned at a given position regardless of the type of punch. Since the punch assisting apparatus is provided with a punch holder combined in one piece, the punch assisting apparatus and punch holder can always be handled together, which makes managing them easier.

### BACKGROUND OF THE INVENTION

1. Field of the Invention

The present invention relates to a punch assisting apparatus used in combination with a punch, which is used for punching an appropriately-shaped hole in a sheet material mainly made of paper or the like to form a sheet member having the appropriately-shaped hole, or to form a patterned sheet material or other goods by adhering the cut out piece on a different sheet material.

More particularly, it relates to a punch assisting apparatus which allows a plurality of punches having different sizes (outer dimensions) to be independently mounted thereon.

2. Description of the Related Art

Heretofore, there have been known punching apparatuses for allowing patterns having different shapes to be cut out by replacing a punch mounted thereon, such punching apparatuses being composed of a punch assisting apparatus and one of a plurality of punches each having a shape different from the others.

As one of the punching apparatuses described above, a punch activating apparatus is disclosed in U.S. Pat. No. 6,145,425 that includes a lever pivotably attached to a bracket on a base and allows an appropriately-shaped pattern to be punched out from a paper sheet or the like by fitting a punch into an aperture of a template and pressing the lever down on the punch, the template being detachably fixed on the base. This punch activating apparatus can be provided with a template having a plurality of differently shaped apertures and a plurality of punches corresponding to the respective apertures, and allows a specified pattern to be punched out by fitting a specified punch into the specifically shaped aperture.

However, although the punch activating apparatus disclosed in the patent document allows appropriately-shaped patterns to be punched out by changing punches, since a plurality of apertures corresponding to a plurality of differently shaped punches are formed in a template, it is necessary to place a matching aperture at a target area every time a punch is changed, which brings about a troublesome process of positioning the template. Additionally, arranging a plurality of apertures in one template consequently causes the size of the template to become large; accordingly, the size of the punch activating apparatus becomes large. Furthermore, since the punch pressing portion is disposed apart from the handle pivoting portion, the length of the handle has to be made longer to reduce the required pressing force, which also causes the size of the punch activating apparatus to become large.

### SUMMARY OF THE INVENTION

The present invention addresses the above problems with the object of providing a punch assisting apparatus such that, when a plurality of punches having different sizes (outer dimensions) are used, changing of a punch can be readily carried out and each punching operation can be performed according to a routine procedure regardless of the type of punch.

In order to achieve the above object, a first aspect of the present invention provides a punch assisting apparatus usable in combination with one of a plurality of punches consisting of an apparatus base and a handle pivotably attached to the apparatus base, wherein the apparatus base has a punch holder integrated therein which allows the plurality of punches having different sizes to be independently positioned and fixed in accordance with their respective sizes, the punch holder being configured so as to provide both a use position and a nonuse position by changing its posture.

A second aspect of the present invention is characterized in that, in the invention of the first aspect, the punch holder is molded in one piece with the apparatus base so as to be pivotable with respect thereto through a holder hinge portion.

A third aspect of the present invention is characterized in that, in the invention of the first or second aspect, the apparatus base is provided with a punch holding portion which allows a punch having a predetermined size to be positioned and fixed, and the punch holder held in a use position is accommodated in the punch holding portion.

Also, to achieve the above object, a fourth aspect of the present invention provides a punch assisting apparatus usable in combination with one of a plurality of punches consisting of an apparatus base being provided with a punch holding portion which allows a punch having a predetermined size to be positioned and fixed and a handle pivotably attached to the apparatus base, wherein a punch holder, which allows a punch having a predetermined size to be positioned and fixed in accordance with its size, is constructed as a component separate from the apparatus base and mounted on the punch holding portion so as to be detachable.

A fifth aspect of the present invention is characterized in that, in the invention of the fourth aspect, the punch holder is constructed from a holder base mounted on the apparatus base and a holder ancillary piled on the holder base, by which a punch having a low profile is allowed to be positioned and fixed.

A sixth aspect of the present invention is characterized in that, in the invention of any one of the first to fifth aspects, the apparatus base includes a sheet holding member for positioning a sheet to be punched at a punching position.

A seventh aspect of the present invention is characterized in that, in the invention of the sixth aspect, the sheet holding member is molded in one piece with the apparatus base so as to be pivotable with respect thereto through a sheet holder hinge portion.

An eighth aspect of the present invention is characterized in that, in the invention of any one of the first to seventh aspects, the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

A punch assisting apparatus according to the first aspect of the present invention is configured such that an apparatus base has a punch holder integrated therein which allows the plurality of punches having different sizes to be independently positioned and fixed in accordance with their respective sizes, the punch holder being configured so as to provide both a use position and a nonuse position by changing its posture; therefore, in the case when a punch is mounted in the punch assisting apparatus to replace the one previously mounted, the punch can be always positioned at a given position regardless of the type of punch. In particular, since the punch assisting apparatus is provided with a punch holder combined in one piece, the punch assisting apparatus and punch holder can be always handled together, which makes managing the punch assisting apparatus and punch holder easier.

According to the second aspect of the present invention, the punch holder is molded in one piece with the apparatus base; therefore, in addition to the effect due to the first aspect, when the punch holder is constructed in one piece with the apparatus base, it becomes possible to mold it simply through one molding process. Moreover, since the punch holder is configured so as to be pivotable with respect to the apparatus base through a holder hinge portion, the punch holder can be readily attached to the apparatus base.

According to the third aspect of the present invention, the apparatus base is provided with a punch holding portion which allows a punch having a predetermined size to be positioned and fixed, and the punch holder is accommodated and fixed in the punch holding portion; therefore, in addition to the effect due to the first or second aspect, any device for positioning the punch holder on the apparatus base is not required to be separately provided.

According to the fourth aspect of the present invention, a punch assisting apparatus has a configuration such that an apparatus base and a punch holder, which allows a punch having a predetermined size to be positioned and fixed in accordance with its size, are constructed as separate components and the punch holder is detachably mounted on a punch holding portion constructed in the apparatus base; therefore, in the case when a punch is mounted to the punch assisting apparatus to replace the one previously mounted, the punch can always be positioned at a given position regardless of the type of punch. In particular, even though a punch holder is constructed separately from the punch assisting apparatus, the punch holder should ideally be mounted on the punch holding portion having been constructed in the apparatus base; therefore, the punch holder can be readily positioned and fixed.

According to the fifth aspect of the present invention, the punch holder is constructed from a holder base mounted on the apparatus base and a holder ancillary piled on the holder base; therefore, in addition to the effect due to the fourth aspect, a punch having a different profile is allowed to be positioned and fixed.

According to the sixth aspect of the present invention, the apparatus base includes a sheet holding member for positioning a sheet to be punched at a punching position; therefore, in addition to the effect due to any one of the first to fifth aspects, the position of the sheet to be punched is fixed and the punching position cannot be deviated.

According to the seventh aspect of the present invention, the sheet holding member is molded in one piece with the apparatus base so as to be pivotable with respect thereto through a sheet holder hinge portion; therefore, in addition to the effect due to the sixth aspect, it becomes possible to mold it simply through one molding process.

According to the eighth aspect of the present invention, the distance between the position where the pressing portion constructed in the handle contacts a punch bit and the position of handle knuckle portions is about a half of the distance between the position of a handle pressing spot and the position of the handle knuckle portions; therefore, in addition to the effect due to any one of the first to seventh aspects, when a punching operation is performed, required force to be applied to the handle can be reduced by half.

### BRIEF DESCRIPTION OF THE DRAWINGS

FIG. 1 is a perspective view of a first embodiment of the punch assisting apparatus provided with an A-type punch;

FIG. 2 is a cross-section view taken from line A-A in FIG. 1, showing the first embodiment of the punch assisting apparatus provided with the A-type punch;

FIG. 3 is a perspective view of the punch assisting apparatus according to the first embodiment with its handle opened to attach or detach the A-type punch;

FIG. 4 is a bottom plan view of the punch assisting apparatus according to the first embodiment;

FIG. 5 is an exploded perspective view of the punch assisting apparatus according to the first embodiment;

FIG. 6 is a perspective view of the punch assisting apparatus according to the first embodiment with a punch holder positioned at a use position;

FIG. 7 is a perspective view of the punch assisting apparatus according to the first embodiment with the punch holder positioned at a nonuse position;

FIG. 8 is a top view of the punch assisting apparatus according to the first embodiment showing a state where its handle is removed;

FIG. 9 is a bottom plan view of the punch assisting apparatus according to the first embodiment showing a state where its handle is removed;

FIG. 10 is a side view of the punch assisting apparatus according to the first embodiment showing a state where its handle is removed;

FIG. 11 is a perspective view of the punch assisting apparatus according to the first embodiment with its handle opened to attach or detach a B-type punch;

FIG. 12 is a perspective view of the punch assisting apparatus according to the first embodiment with its handle opened to attach or detach a C-type punch;

FIG. 13 is a side view of a second embodiment of the punch assisting apparatus;

FIG. 14 is a side view of the second embodiment of the punch assisting apparatus provided with the A-type punch;

FIG. 15 is a side view of the second embodiment of the punch assisting apparatus provided with the A-type punch, showing a state where its handle is slightly depressed;

FIG. 16 is a side view of the second embodiment of the punch assisting apparatus provided with the A-type punch, showing a state where its handle is fully depressed;

FIG. 17 is an exploded perspective view of the punch assisting apparatus according to the second embodiment;

FIG. 18 is a top view of the punch assisting apparatus according to the second embodiment showing a state where its handle is removed;

FIG. 19 is a bottom plan view of the punch assisting apparatus according to the second embodiment showing a state where its handle is removed;

FIG. 20 is a side view of the punch assisting apparatus according to the second embodiment showing a state where its handle is removed;

FIG. 21 is a cross-section view taken from line B-B in FIG. 20;

FIG. 22 is a side view of the punch assisting apparatus according to the second embodiment shown in FIG. 20 with its sheet holding members opened;

FIG. 23 is a top view of the punch holder used for the punch assisting apparatus according to the second embodiment;

FIG. 24 is a side view of the punch holder shown in FIG. 23;

FIG. 25 is a bottom plan view of the punch holder shown in FIG. 23;

FIG. 26 is a perspective view of the punch assisting apparatus according to the second embodiment with its handle opened to attach or detach the B-type punch;

FIG. 27 is a perspective view of the punch assisting apparatus according to the second embodiment with its handle opened to attach or detach a D-type punch;

FIG. 28 is a side view of the second embodiment of the punch assisting apparatus provided with the D-type punch, showing a state where its handle is slightly depressed; and

FIG. 29 is a side view of the second embodiment of the punch assisting apparatus provided with the D-type punch, showing a state where its handle is fully depressed.

### DESCRIPTION OF THE PREFERRED EMBODIMENTS

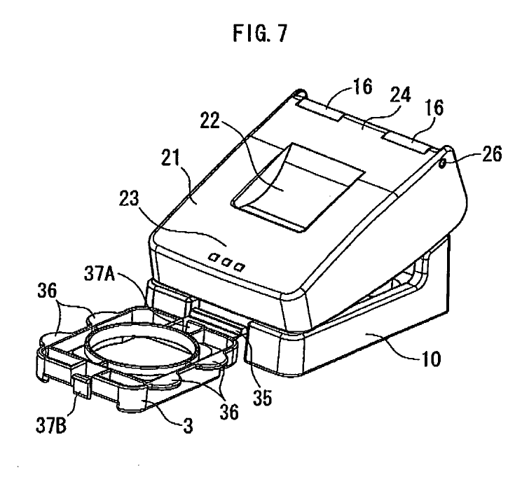

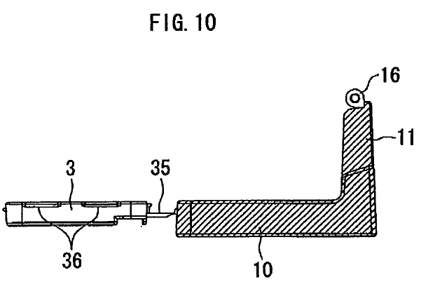

A punch assisting apparatus according to a first embodiment of the present invention will now be described with reference to FIGS. 1 to 12.

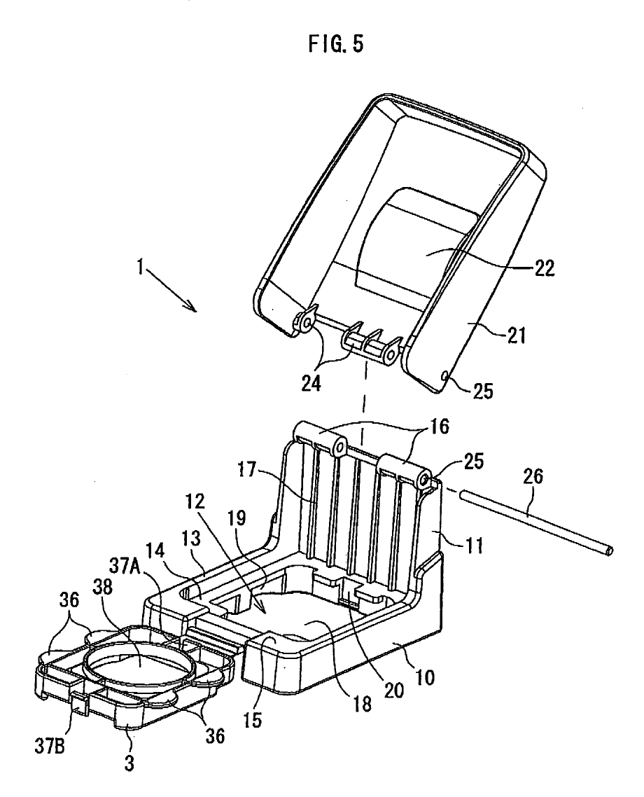

As shown in FIG. 1, the punch assisting apparatus 1 is configured such that an appropriately-shaped pattern and the like can be cut out from a sheet to be punched (not shown) by pressing down a handle 21, the sheet being inserted into a clearance 61 of an A-type punch 5A, which is for example fit in a punch holding portion 12 (a space formed by holding sidewalls 13, a holding bottom wall 14, a holding front wall 15, and a handle support 11; see FIG. 5).

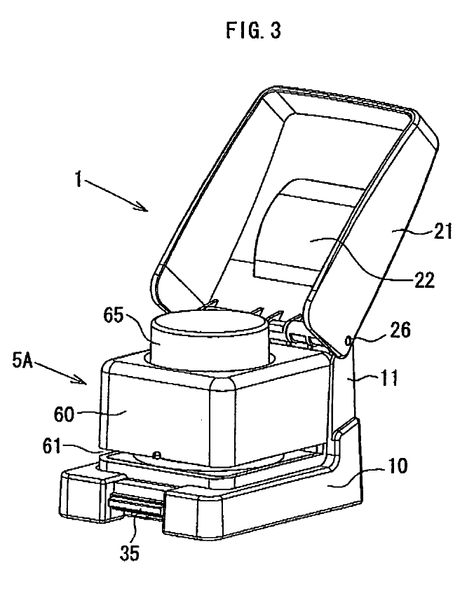

The punch assisting apparatus 1 is also configured such that when the A-type punch 5A is attached or detached, a space above an apparatus base 10 is revealed by raising the handle 21 upward to allow the A-type punch 5A to be readily attached or detached, as shown in FIG. 3.

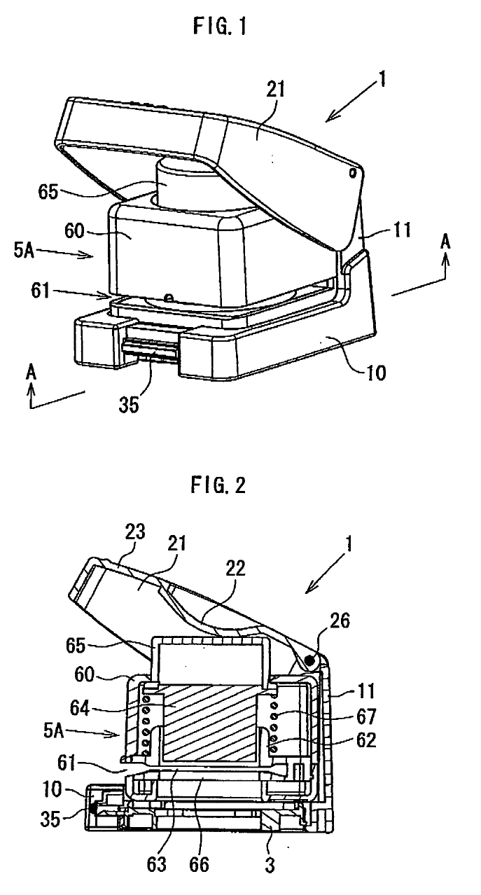

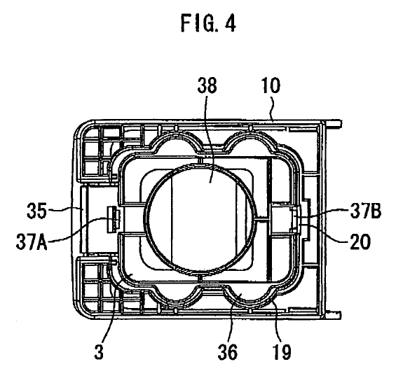

It should be noted that, in the case when the A-type punch 5A is fitted to the punch assisting apparatus 1, a punch holder 3 constructed in one piece with the apparatus base 10 is accommodated in the space behind the apparatus base 10, as shown in FIGS. 2 and 4. It should also be noted that sheet holding members can be integrated with the apparatus base of the punch assisting apparatus according to the first embodiment as with the punch assisting apparatus according to a second embodiment described later.

The punch assisting apparatus 1 according to the first embodiment is basically constructed of the apparatus base 10, the punch holder 3 pivotably coupled to the apparatus base 10 via a holder hinge portion 35, and the handle 21 pivotably attached to the handle support 11 of the apparatus base 10 as shown in the exploded perspective view of FIG. 5.

While the apparatus base 10, punch holder 3 and handle 21 constituting the punch assisting apparatus 1 are made from an appropriate soft synthetic resin material, for example polypropylene (PP) resin, other synthetic resin materials such as polyacetal (POM), nylon 6 (PA6), nylon 66 (PA66), low-density polyethylene (PE) or the like can also be employed. In particular, the apparatus base 10 and punch holder 3 are constructed in one piece with the holder hinge portion 35 by means of, for example, injection molding. If the components constituting the punch assisting apparatus 1 are thus constructed from soft synthetic resin like PP resin, the holder hinge portion 35 can be thinly formed so as to be pivotable. Moreover, when for example the A-type punch 5A is attached to or detached from the punch assisting apparatus 1, a soft material effectively prevents the A-type punch 5A from being damaged. Also, in the case of a B-type punch, C-type punch and D-type punch described later, damage incurred during attachment or detachment can be prevented. Incidentally, a punch is generally, in most cases, constructed from ABS resin except for the punch bit and punch base, ABS resin being harder than PP resin.

The respective components constituting the punch assisting apparatus 1 will now be described below.

As shown in FIGS. 2 and 5, the apparatus base 10 of the punch assisting apparatus 1 is partitioned horizontally by the holding bottom wall 14 in its substantially middle part, and the punch holding portion 12 is formed in the top face of the holding bottom wall 14 on which the A-type punch 5A is to be mounted. Furthermore, an open portion allowing the punch holder 3 to be accommodated when not infuse is formed in the backside of the holding bottom wall 14. A base opening 18 is also formed in the holding bottom wall 14 so as to pass through a substantially central portion thereof.

The handle support 11 for supporting the handle 21 is constructed vertically in a rear portion of the apparatus base 10 in one piece therewith. The handle support 11 is provided with a plurality of ribs 17 in its front face, the ribs 17 being constructed vertically in one piece with the handle support 11 so as to project toward the side of the punch holding portion, and also provided with a pair of support knuckle portions 16 in the top end thereof, the support knuckle portions 16 being constructed in one piece with the handle support 11. In each of the support knuckle portions 16, a pivot hole 25 for inserting a pivot pin 26 described later is formed.

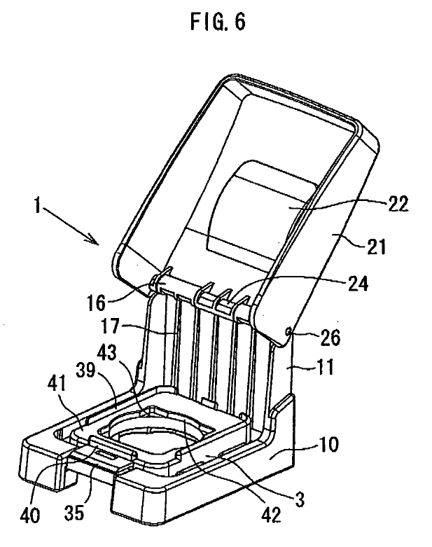

The punch holding portion 12 formed on the upper face of the apparatus base 10 is a space defined by the holding bottom wall 14, holding sidewalls 13, holding front wall 15, and handle support 11 as shown in FIG. 5, and is configured such that the A-type punch 5A can be positioned and fixed as shown in FIGS. 1 to 3. Additionally, in the holding front wall 15, a groove portion is formed which holds the holder hinge portion 35 of the punch holder 3 described later when the punch holder 3 is accommodated in the punch holding portion 12 (see FIG. 6).

On the other hand, as shown in FIGS. 4, 5 and 9, in the open portion formed in the backside of the holding bottom wall 14 of the apparatus base 10, there are formed concave fixing portions 19 that engage with convex fixing portions 36 of the punch holder 3, and a lug hooking portion 20 joined with a hooking lug 37B of the punch holder 3 when the punch holder 3 is accommodated in a nonuse position.

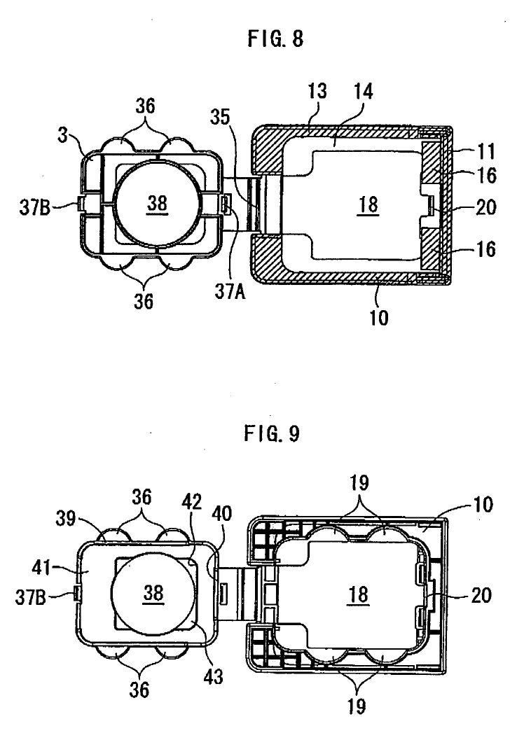

The punch holder 3 and apparatus base 10 are connected with each other in one piece via the holder hinge portion 35, as shown in FIG. 5, and FIGS. 8 to 10. Since the punch holder 3 is formed in one piece with the apparatus base 10, the backside of the punch holder 3 is oriented upward when developed as shown in FIG. 5. The punch holder 3 is accommodated in the open portion formed in the backside of the apparatus base 10 as shown in FIGS. 2 and 4 when not in use, and is accommodated in the punch holding portion 12 of the apparatus base 10 to allow the B-type punch 5B or C-type punch 5C to be positioned and fixed as shown in FIG. 6 when in use.

The punch holder 3 has a holding lug 37A formed on the side of the holder hinge portion 35, the holding lug 37A being joined to a front edge portion of the base opening 18 of the apparatus base 10 when the punch holder 3 is held in the use position (see FIG. 6), and also has the holding lug 37B formed on the free end side opposite to the holder hinge portion 35, the holding lug 37B being joined to the lug hooking portion 20 when the punch holder 3 is held in the nonuse position (see FIG. 4). Furthermore, the punch holder 3 has the convex fixing portions 36 formed at both sides thereof so as to project laterally, the convex fixing portions 36 being engaged with and fixed to the concave fixing portions 19 of the apparatus base 10, when the punch holder 3 is held in the nonuse position (see FIGS. 2 and 4). Note that a holder opening 38 is formed in a central portion of the punch holder 3.

As shown in FIG. 6, a B-type punch holding portion and a C-type punch holding portion are each configured on the top face of the punch holder 3 when it is accommodated in the punch holding portion 12 of the apparatus base 10. The B-type punch holding portion is formed of B-type punch holding sidewalls 39, a B-type punch holding front wall 40, a B-type punch holding bottom wall 41, and the holding lug 37B, which also serves as a B-type punch holding rear wall, extending substantially along the periphery of the punch holder 3. The C-type punch holding portion is formed by cutting out concave portions from the B-type punch holding bottom wall 41 so as to position it inside the B-type punch holding portion. Since the holder opening 38 is formed in the punch holder 3, the C-type punch holding portion is configured from C-type punch holding side faces 42 and C-type punch holding bottom faces 43 so that a C-type punch is placed on the four corners of the holder opening 38.

While the apparatus base 10 and punch holder 3 of the punch assisting apparatus 1 are constructed basically as described above, they can be molded in one piece with the holder hinge portion 35 therebetween as shown in FIGS. 8 to 10 by, for example, injecting melted PP resin into an injection molding mold and solidifying it therein.

The handle 21 is formed in a substantially cap-like shape having an open backside so as to cover the punch holding portion 12 of the apparatus base 10 from above as shown in FIGS. 1 and 2. In a rear end portion of the handle 21, handle knuckle portions 24 are formed in one piece with the handle 21, the handle knuckle portions 24 being each provided with a pivot hole 25 for inserting the pivot pin 26 (see FIG. 5). When the handle 21 is attached to the handle support 11 of the apparatus base 10, the pivot pin 26 is inserted through the pivot holes 25 of the handle knuckle portions 24 and also the pivot holes 25 of the support knuckle portions 16; whereby the handle 21 becomes freely pivotable with respect to the handle support 11.

Additionally, the handle 21 is provided with a pressing portion 22 formed in its substantially central portion so as to project curvedly toward the side of the punch holding portion 12, the pressing portion 22 being configured so as to contact the top surface of a punch bit head 65 of the A-type punch 5A when the A-type punch 5A is mounted in the punch assisting apparatus 1, as shown in FIG. 2. When punching operation is carried out, the punch bit head 65 is pressed via the pressing portion 22 by pressing a handle pressing spot 23 downward, the handle pressing spot 23 being formed on the top face of a front edge portion of the handle 21. It should be noted that the distance between the position where the pressing portion 22 of the handle 21 contacts the punch bit head 65 of the A-type punch 5A (punch contact position) and the pivot pin 26 (handle knuckle portions) is set to be about a half of the distance between the handle pressing spot 23 and the pivot pin 26 (handle knuckle portions).

A punching operation using the punch assisting apparatus 1 according to the first embodiment will now be described.

First, a punching operation by use of the A-type punch 5A will be described. In this operation, the punch holder 3 is accommodated in the backside of the apparatus base 10; wherein the convex fixing portions 36 of the punch holder 3 are engaged with the concave fixing portions 19 of the apparatus base 10, and the holding lug 37B is joined to the lug hooking portion 20 of the apparatus base 10, by which the punch holder 3 is fixed in a nonuse position, as shown in FIGS. 2 and 4.

Then, as shown in FIG. 3, the handle 21 is pivoted upwardly to open a space above the punch holding portion 12, which is defined by the holding bottom wall 14, holding sidewalls 13, holding front wall 15, and handle support 11; after that, the A-type punch 5A is installed in the punch holding portion 12 as shown in FIG. 1.

In a state in which the A-type punch 5A is thus mounted in the punch assisting apparatus 1, a sheet to be punched (not shown) is inserted through the clearance 61 of the A-type punch 5A into a slit 63 of the punch base 62 and is positioned. After that, the punch bit head 65 of the A-type punch 5A is depressed by pressing the handle pressing spot 23 downward via the pressing portion 22 of the handle 21, which allows a punch bit 64 to move downward along a guide hole 66 of the punch base 62, and a tip portion of the punch bit 64 to contact an edge formed in the portion where the slit 63 and guide hole 66 intersect with each other; an appropriately-shaped pattern and the like can be thus cut out from the sheet to be punched.

After the punching operation is completed, upon release of the force having been applied to the handle pressing spot 23, the punch bit head 65 is lifted by the spring force of a spring 67, and the handle 21 is accordingly raised upward to return to the position shown in FIG. 1.

Next, a punching operation by use of the B-type punch 5B will be described. In the case when the B-type punch 5B is used, the punch holder 3 is turned from the state shown in FIG. 1 to that shown in FIG. 6, accommodated in the punch holding portion 12 of the apparatus base 10, and fixed by joining the holding lug 37A to the front edge portion of the base opening 18. In this state, the holder hinge portion 35 of the punch holder 3 is held in the groove portion formed in the holding front wall 15, by which the punch holder 3 is secured so that both the B-type punch holding portion and C-type punch holding portion are oriented upward.

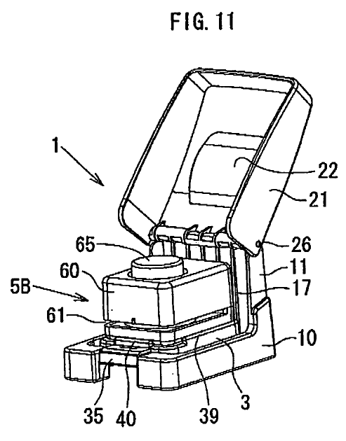

Then, as shown in FIG. 11, the B-type punch 5B is positioned and fixed in the B-type punch holding portion formed of the B-type punch holding sidewalls 39, B-type punch holding front wall 40, B-type punch holding bottom wall 41, and holding lug 37B. Detailed description of the punching process to be followed is omitted since it is similar to the case of the A-type punch 5A.

Furthermore, in the case when the C-type punch 5C is used, the punch holder 3 is turned from the state shown in FIG. 1 to that shown in FIG. 6, accommodated in the punch holding portion 12 of the apparatus base 10, and fixed by joining the holding lug 37A to the front edge portion of the base opening 18, as with the case when the B-type punch 5B is used.

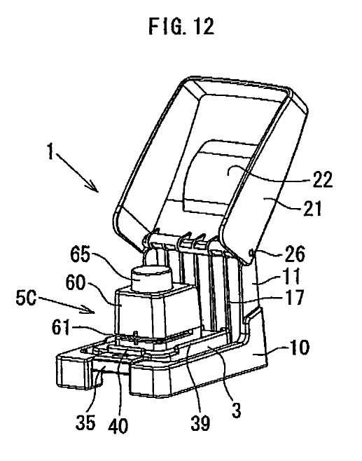

Then, as shown in FIG. 12, the C-type punch holding portion is positioned and fixed in the C-type punch holding portion that is formed of the C-type punch holding side faces 42 and C-type punch holding bottom faces 43 so that the C-type punch is placed on the four corners of the holder opening 38. Detailed description of the punching process to be followed is omitted since it is similar to the case of the A-type punch 5A and B-type punch 5B.

While the punch assisting apparatus 1 including the punch holder 3 as one piece has been described, it is possible to construct a punch holder 3 as a separate component and to mount it on the apparatus base 10 so as to be slidable or detachable. Also, while the punch holding portion of the punch holder 3 described in the above serves as both the A-type punch holding portion and B-type punch holding portion, a punch holding portion for one type of punch may be employed. Furthermore, while the punch assisting apparatus 1 including the punch holding portion 12 is described above, it is possible to form only the base opening 18 in the apparatus base 10 and to omit the punch holding portion 12.

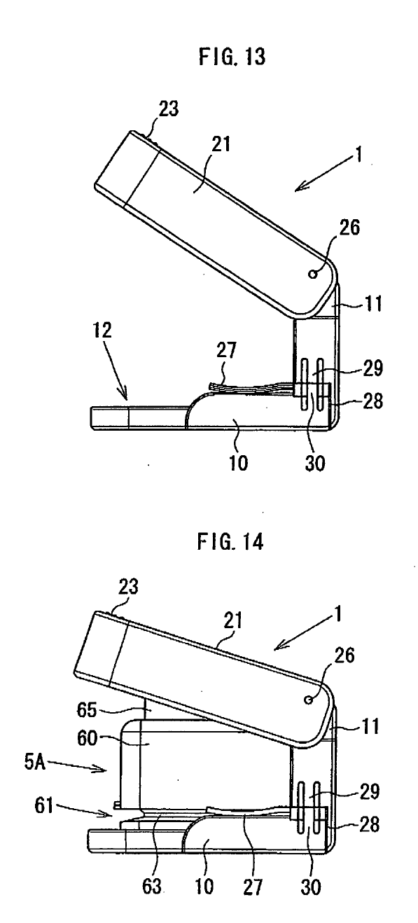

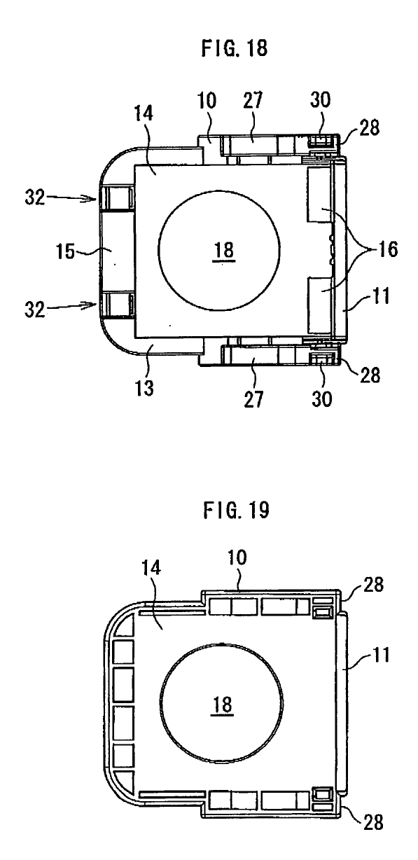

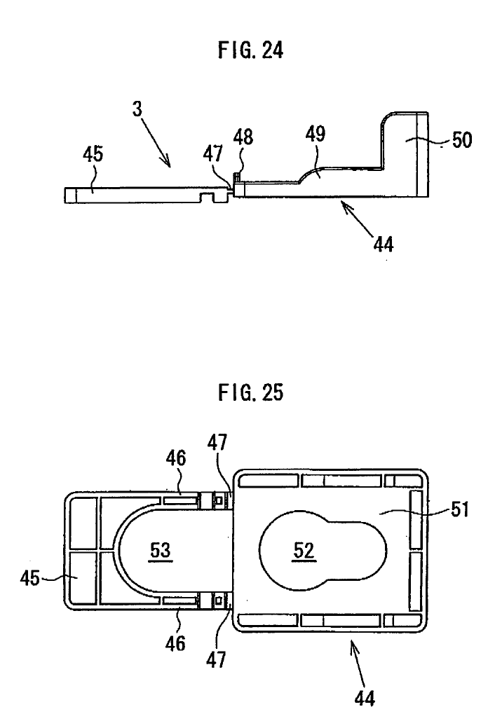

Now, a punch assisting apparatus according to a second embodiment of the present invention will be described with reference to FIGS. 13 to 29. The punch assisting apparatus according to the second embodiment is different from the punch assisting apparatus according to the first embodiment particularly from the viewpoint that a punch holder 3 is constructed as a component separate from an apparatus base 10, and sheet holding members 27 for positioning and fixing a sheet to be punched at a punching position are integrated in the apparatus base 10.

As shown in FIGS. 13, 14 and 17, the punch assisting apparatus 1 is configured such that an appropriately-shaped pattern and the like can be cut out from a sheet to be punched (not shown) by pressing down a handle 21, the sheet being inserted into a clearance 61 of an A-type punch 5A, which is for example fit in a punch holding portion 12 (a space defined by holding sidewalls 13, a holding bottom wall 14, a holding front wall 15, and a handle support 11).

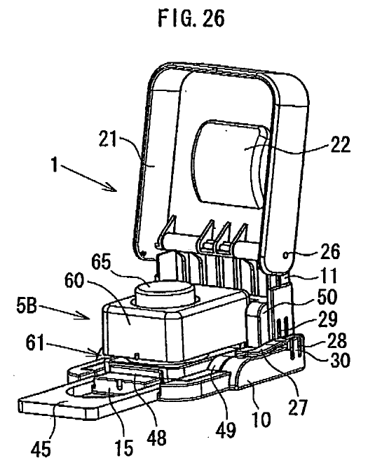

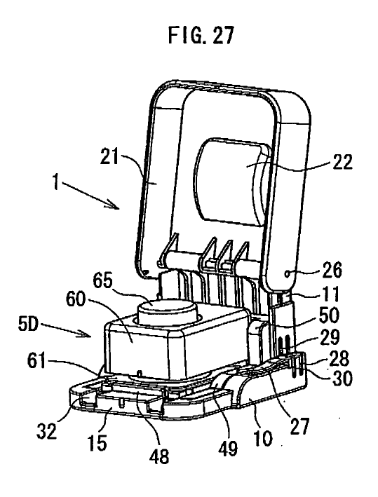

The punch assisting apparatus 1 is also configured such that when the A-type punch 5A is attached or detached, a space above the apparatus base 10 is revealed by raising the handle 21 upward to allow the A-type punch 5A to be readily attached or detached. While, when the A-type punch 5A is mounted in the punch assisting apparatus 1 for use, the punch holder 3 is not installed on the apparatus base 10 as shown in FIGS. 13 to 16, when a B-type punch 5B or D-type punch 5D is mounted in the punch assisting apparatus 1 for use, the punch holder 3 is installed on the apparatus base 10 as shown in FIGS. 26 and 27.

In the following paragraphs, the points different from the punch assisting apparatus 1 according to the first embodiment will be mainly described.

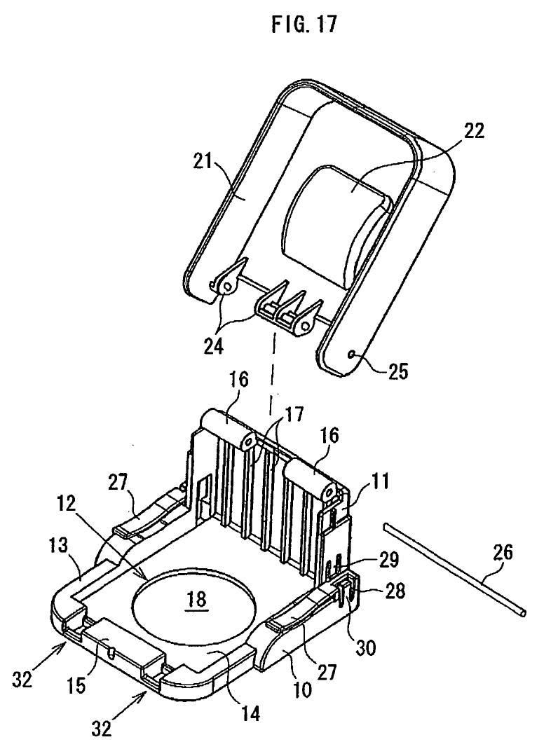

A punch assisting apparatus 1 according to the second embodiment consists of two basic structural parts: an apparatus base 10 including sheet holding members 27 constructed in one piece therewith and a handle 21 pivotably mounted on a handle support 11 of the apparatus base 10, as shown in the exploded perspective view of FIG. 17, and becomes usable by combining a punch holder 3, shown in FIGS. 23 to 25, with the basic structural parts.

The apparatus base 10, which includes the sheet holding members 27 in one piece, the handle 21 and the punch holder 3 are made from an appropriate soft synthetic resin material, for example polypropylene (PP) resin, as in the case of the punch assisting apparatus 1 according to the first embodiment; however, other synthetic resin materials such as polyacetal (POM), nylon 6 (PA6), nylon 66 (PA66), low-density polyethylene (PE) or the like may also be employed. In particular, the apparatus base 10 and sheet holding members 27 are constructed in one piece with sheet holder hinge portions 28, and a holder base 44 and holder ancillary 45 of the punch holder 3 are constructed in one piece with ancillary hinge portions 47 by means of, for example, injection molding.

As shown in FIGS. 17 to 22, the apparatus base 10 of the punch assisting apparatus 1 has the punch holding portion 12 in the space defined by the holding bottom wall 14, holding sidewalls 13, holding front wall 15, and holding front wall 15. The holding bottom wall 14 is formed so that its undersurface is in the same plane as the undersurface of the apparatus base 10 as shown in FIG. 21, and configured so that a D-type punch 5D (see FIG. 27) can be mounted in the space formed by the punch holding portion 12 and the top surface of the holder ancillary 45, when the punch holder 3 is mounted in the punch holding portion 12 in a state that the holder ancillary 45 is piled on the holder base 44. Additionally, in the holding front wall 15, a holding groove 32 is formed which holds ancillary bases 46 and ancillary hinge portions 47 of the punch holder 3 described later when the holder base 44 of the punch holder 3 is accommodated in the punch holding portion 12 (see FIG. 26).

The handle support 11 for supporting the handle 21 is configured similarly with the punch assisting apparatus 1 according to the first embodiment.

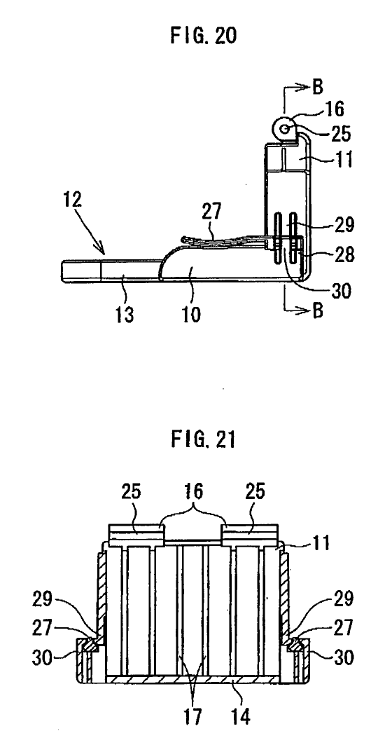

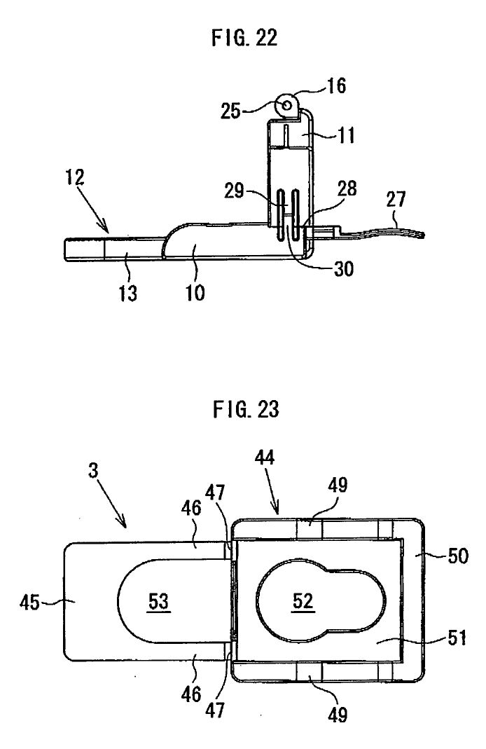

The sheet holding members 27 are connected to form one piece at rear edges thereof on both sides (rear edges of the respective holding sidewalls 13) of the apparatus base 10 via the sheet holder hinge portion 28, as shown in FIGS. 20 to 22. The apparatus base 10 and sheet holding members 27, which are connected via the sheet holder hinge portion 28 as shown in FIG. 22, can be molded in one piece by, for example, injecting melted PP resin into an injection molding mold and solidifying it therein. On the occasion of molding, flexible portions 29 and pinching portions 30, which hold the sheet holding members 27 at predetermined positions respectively, are also molded in one piece. The tip portions of the flexible portions 29 and pinching portions 30 are molded so as to project toward the base portion of the sheet holding members 27, and hold the sheet holding members 27 to be positioned at their predetermined positions (see FIG. 21). Moreover, both sides of the respective flexible portions 29 and pinching portions 30 are notched to allow both the flexible portions 29 and pinching portions 30 to be bendable.

The punch holder 3 is constructed in a manner such that the holder base 44 accommodated in the punch holding portion 12 of the apparatus base 10 and the holder ancillary 45 placed on a holder bottom wall 51 of the holder base 44 in a pile are formed in one piece via the ancillary hinge portion 47, as shown in FIGS. 23 to 25.

The holder ancillary 45 is connected by a pair of ancillary bases 46 located on both sides of an ancillary opening 53 to the holder base 44 via the ancillary hinge portions 47. A holder opening 52 is formed in the holder base 44.

In the holder base 44, a B-type punch holding portion is formed of a holder front wall 48, holder side walls 49, a holder rear wall 50 and a holder bottom wall 51 (see FIG. 26). Additionally, the holder ancillary 45 is piled on the holder bottom wall 51 of the holder base 44; whereby a D-type punch holding portion for installing a D-type punch 5D is configured so as to be a space formed by the top surface of the holder ancillary 45, holder front wall 48, holder side walls 49 and holder rear wall 50 (see FIG. 27).

The punch holder 3 is constructed as a component separate from the apparatus base 10, and the holder base 44 and holder ancillary 45, which are connected via the ancillary hinge portions 47 as shown in FIGS. 23 to 25, can be molded in one piece by, for example, injecting melted PP resin into an injection molding mold and solidifying it therein.

A punching operation using the punch assisting apparatus 1 according to the second embodiment will now be described.

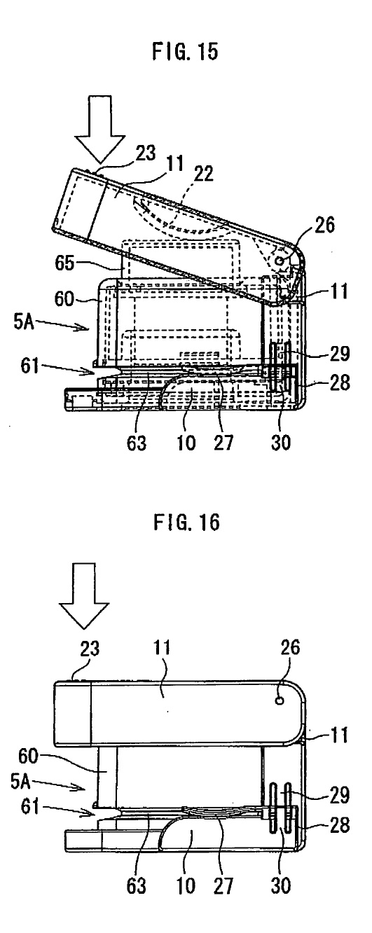

First, a punching operation by use of the A-type punch 5A will be described. In this operation, the A-type punch 5A is mounted in the punch holding portion 12, as shown in FIGS. 14 and 15.

When a sheet to be punched (not shown) is inserted through the clearance 61 of the A-type punch 5A into a slit 63 of a punch base 62 in a state that the A-type punch 5A is thus mounted to the punch assisting apparatus 1, an edge of the inserted sheet to be punched touches the sheet holding members 27, but the sheet to be punched can be pushed in between the sheet holding members 27 and holding sidewalls 13 by allowing the sheet holding members 27 to be deformed and stops in a state in which it touches the front surface of the handle support 11. Consequently, the sheet to be punched is held elastically between the sheet holding members 27 and holding sidewalls 13 to be prevented from moving, which enables the sheet to be punched to be positioned with greater certainty.

After that, as shown in FIGS. 15 and 16, a handle pressing spot 23 is pressed down to allow a punch bit head 65 to be depressed, whereby an appropriately-shaped pattern and the like can be cut out from the sheet to be punched in a fully depressed state shown in FIG. 16.

After the punching operation is completed, upon release of the force having been applied to the handle pressing spot 23, the punch bit head 65 is lifted by the spring force of a spring (not shown), and the handle 21 is accordingly raised upward to return to the position shown in FIG. 15.

Next, when the B-type punch 5B is used, the holder base 44 of the punch holder 3 is accommodated in the punch holding portion 12 of the apparatus base 10 and fixed there as shown in FIG. 26. In this state, the ancillary bases 46 and ancillary hinge portions 47 of the holder ancillary 45 are held and fixed in the holding groove 32 formed in the holding front wall 15 of the apparatus base 10, and the B-type punch holding portion is formed of the holder front wall 48, holder side walls 49, a holder rear wall 50 and a holder bottom wall 51. Then, the B-type punch 5B is positioned and fixed in the B-type punch holding portion. Detailed description of the punching process to be followed is omitted since it is similar to the case of the A-type punch 5A.

In the case when the D-type punch 5D is used, as shown in FIG. 27, the D-type punch holding portion for mounting the D-type punch 5D is configured so as to be a space defined by the top surface of the holder ancillary 45, holder front wall 48, holder side walls 49 and holder rear wall 50. Then, the D-type punch 5D is positioned and fixed in the D-type punch holding portion.

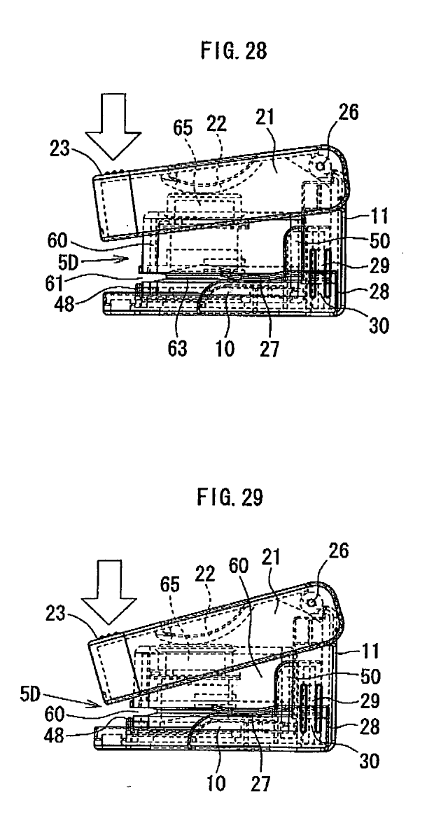

Although detailed description of the punching process to be followed is omitted since it is similar to the cases of the A-type punch 5A and B-type punch 5B, since the profile of the D-type punch 5D is lower than that of the A-type punch 5A, the handle 21 of the punch assisting apparatus 1 equipped with the punch holder 3, in which the D-type punch 5D is installed, tilts slightly downward as compared with its horizontal position at initiation of pressing operation, as shown in FIG. 28. For this reason, the distance between the position where the pressing portion 22 of the handle 21 contacts the punch bit head 65 of the D-type punch 5D (punch contact position) and the pivot pin 26 (handle knuckle portions) is larger to some extent than the case of the A-type punch 5A.

While the punch assisting apparatus 1 on which the punch holder 3 is detachably mounted has been described, the punch holder 3 may be constructed in one piece with the apparatus base 10 as in the case of the punch assisting apparatus 1 of the first embodiment. Also, while the sheet holding members 27 constructed in one piece with the apparatus base 10 have been described, the sheet holding members 27 may be formed as separate members and each attached detachably to the apparatus base 10.

What is claimed is:

1. A punch assisting apparatus usable in combination with one of a plurality of punches, comprising:
an apparatus base; and
a handle pivotably attached to the apparatus base,
wherein the apparatus base has a punch holder integrated therein which allows the plurality of punches having different sizes to be independently positioned and fixed in accordance with their respective sizes, the punch holder being configured so as to provide both a use position and a nonuse position by changing its posture.

2. The punch assisting apparatus according to claim 1,
wherein the punch holder is molded in one piece with the apparatus base so as to be pivotable with respect thereto through a holder hinge portion.

3. The punch assisting apparatus according to claim 1,
wherein the apparatus base is provided with a punch holding portion which allows a punch having a predetermined size to be positioned and fixed, and the punch holder held in a use position is accommodated in the punch holding portion.

4. A punch assisting apparatus usable in combination with one of a plurality of punches, comprising:
an apparatus base being provided with a punch holding portion which allows a punch having a predetermined size to be positioned and fixed; and
a handle pivotably attached to the apparatus base,
wherein a punch holder, which allows a punch having a predetermined size to be positioned and fixed in accordance with its size, is constructed as a component separate from the apparatus base and mounted on the punch holding portion so as to be detachable.

5. The punch assisting apparatus according to claim 4,
wherein the punch holder is constructed from a holder base mounted on the apparatus base and a holder ancillary piled on the holder base, by which a punch having a low profile is allowed to be positioned and fixed.

6. The punch assisting apparatus according to claim 1,
wherein the apparatus base includes a sheet holding member for positioning a sheet to be punched at a punching position.

7. The punch assisting apparatus according to claim 6,
wherein the sheet holding member is molded in one piece with the apparatus base so as to be pivotable with respect thereto through a sheet holder hinge portion.

8. The punch assisting apparatus according to claim 1,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

9. The punch assisting apparatus according to claim 2,
wherein the apparatus base is provided with a punch holding portion which allows a punch having a predetermined size to be positioned and fixed, and the punch holder held in a use position is accommodated in the punch holding portion.

10. The punch assisting apparatus according to claim 2,
wherein the apparatus base includes a sheet holding member for positioning a sheet to be punched at a punching position.

11. The punch assisting apparatus according to claim 3,
wherein the apparatus base includes a sheet holding member for positioning a sheet to be punched at a punching position.

12. The punch assisting apparatus according to claim 4,
wherein the apparatus base includes a sheet holding member for positioning a sheet to be punched at a punching position.

13. The punch assisting apparatus according to claim 5,
wherein the apparatus base includes a sheet holding member for positioning a sheet to be punched at a punching position.

14. The punch assisting apparatus according to claim 2,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

15. The punch assisting apparatus according to claim 3,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

16. The punch assisting apparatus according to claim 4,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

17. The punch assisting apparatus according to claim 5,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

18. The punch assisting apparatus according to claim 6,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.

19. The punch assisting apparatus according to claim 7,
wherein the handle includes a pressing portion for pressing a punch, and is configured so that the distance between the position where the pressing portion contacts a punch bit and the position of handle knuckle portions is about a half of the distance between the position of a handle pressing spot and the position of the handle knuckle portions.
